(19) United States
(12) Patent Application Publication
(10) Pub. No.: US 2012/0228416 A1
(43) Pub. Date: Sep. 13, 2012

(54) LIFTER BAR

(75) Inventors: David J. Page, Elora (CA); Pramod Kumar, Waterloo (CA); Raj K. Rajamani, Salt Lake City, UT (US); Robert Mepham, Fergus (CA)

(73) Assignee: POLYCORP LTD., Elora, ON (CA)

(21) Appl. No.: 13/510,670

(22) PCT Filed: Nov. 19, 2010
(86) PCT No.: PCT/CA2010/001836

§ 371 Date: May 18, 2012

Related U.S. Application Data
(60) Provisional application No. 61/262,730, filed on Nov. 19, 2009.

(51) Int. Cl. B02C 17/18

(52) U.S. Cl. 241/181

(57) ABSTRACT

A lifter bar for lifting an engaged portion of a load comprising a number of ore pieces above a disengaged portion of the load in a grinding mill having a shell rotatable about an axis thereof. The lifter bar includes a leading face having one or more leading surfaces, and a trailing face. The lifter bar is mountable on the shell located at a predetermined distance from a trailing face of a preceding lifter bar. When the lifter bar and the preceding lifter bar are mounted on the shell, the leading face and the trailing face of the preceding lifter bar at least partially define a pocket therebetween in which a part of the engaged portion of the load is at least partially retainable, until the leading surface is located in a predetermined release position, at which the part has substantially exited the pocket under the influence of gravity.

### FIELD OF THE INVENTION

The present invention is a lifter bar for lifting a part of an engaged portion of a load above a disengaged portion of the load in a grinding mill.

### BACKGROUND OF THE INVENTION

Conventional grinding mills may be of various types, including autogenous or semi-autogenous. In known autogenous grinding mills, a portion of a charge including ore-bearing rocks received in a shell thereof is lifted as the shell rotates, and the lifted portion is allowed to fall on a non-lifted portion of the charge, for comminution of the ore-bearing rocks. As is well known in the art, the ore-bearing rocks are thereby at least partially broken, i.e., due to a cataracting or tumbling motion resulting from the rotation of the shell.

In a semi-autogenous mill, a load is received in the shell. The load includes the charge and grinding media (e.g., steel balls). When the shell is rotated, a portion of the load is lifted, and the lifted portion of the load is allowed to fall on a non-lifted portion thereof. In semi-autogenous mills, as a result of the cataracting or tumbling motion of the load when the shell rotates, the ore-bearing rocks are reduced in size both due to collision, or compressive force, exerted by the ore-bearing rocks on each other, and also due to attrition, i.e., the grinding action on the ore-bearing rock positioned between the grinding media.

Typically, in conventional autogenous and semi-autogenous grinding mills, lifter bars are positioned on the shell, extending between a feed end of the shell (at which the charge is introduced into the shell) and a discharge end (at which the charge exits the shell, after comminution thereof). The typical lifter bar has a surface substantially radially aligned with the shell's axis of rotation, and it is this surface on which part of the load rests as the part is lifted. In autogenous mills, the known lifter bars are intended to lift the lifted portion of the charge higher than the lifted portion otherwise would have been lifted, and to release the lifted portion from the higher position, for more rapid comminution of the ore. Similarly, in conventional semi-autogenous mills, the known lifter bars are intended to lift the lifted portion of the load higher than the lifted portion otherwise would have been lifted, and to release the lifted portion from the higher position, for more rapid comminution of the ore.

Conventional lifter bars are used in many types of mills, i.e., in addition to autogenous and semi-autogenous mills. In addition, various types of grinding are known, e.g., dry grinding or wet grinding, and conventional lifter bars are used in a wide variety of grinding applications.

However, the known lifter bars have some disadvantages. For example, assuming (for discussion purposes) a clockwise rotation, the portion of the load which is lifted by a lifter bar typically is released therefrom due to gravity a relatively low height, e.g., at about the nine o'clock position.

### SUMMARY OF THE INVENTION

For the foregoing reasons, there is a need for a lifter bar that will address or mitigate one or more of the disadvantages of the prior art. In particular, there is a need for a lifter bar that retains a part of a lifted portion of a load to a higher height before its release than do conventional lifter bars. (As will be described, for the purposes hereof, a “load” is intended to refer to a charge alone only if the grinding mill is an autogenous grinding mill. Also, for the purposes hereof, a “load” is intended to refer collectively to a charge and grinding media in a semi-autogenous grinding mill.)

In its broad aspect, the invention provides a lifter bar for lifting an engaged portion of a load comprising a number of ore pieces above a disengaged portion of the load in a grinding mill having a shell rotatable about an axis thereof in a direction of rotation. The lifter bar includes a leading face formed for facing in the direction of rotation, the leading face comprising at least one leading surface, and a trailing face, formed for facing in a direction opposite to the direction of rotation. The lifter bar is mountable on the shell located at a predetermined distance from a trailing face of a preceding lifter bar, the preceding lifter bar being positioned relative to the lifter bar in the direction of rotation. When the lifter bar and the preceding lifter bar are mounted on the shell, the leading face is positioned relative to the trailing face of the preceding lifter bar to at least partially define a pocket therebetween in which at least a part of the engaged portion of the load is retainable as the part is raised above the disengaged portion, the part being at least partially retainable in the pocket until said at least one leading surface is located in a predetermined release position, at which the part has substantially exited the pocket under the influence of gravity.

In another aspect, the leading face extends between a leading outer end positioned proximal to the shell and a leading inner end positioned between the leading outer end and the axis, when the lifter bar is mounted on the shell, and the leading surface extends from the leading inner end toward the leading outer end. When the lifter bar is mounted on the shell, the leading surface is located at a preselected leading surface angle relative to a leading surface tangent therefor, the leading surface tangent being tangential to the shell and substantially orthogonal to a first radius through the axis and the leading inner end.

In yet another aspect, the preselected leading surface angle is an acute angle.

In another of its aspects, the invention provides a lifter bar assembly for lifting an engaged portion of a load comprising a number of ore pieces above a disengaged portion of the load in a grinding mill having a shell rotatable about an axis thereof in a direction of rotation. The lifter bar assembly includes a number of pairs of lifter bars, each pair of lifter bars including a leading lifter bar mountable on the shell and having a first trailing face formed for facing away from the direction of rotation, and a trailing lifter bar mountable on the shell at a predetermined distance from the first trailing face of the leading lifter bar, the trailing lifter bar being positioned relative to the leading lifter bar in a direction opposite to the direction of rotation, the trailing lifter bar having a second leading face formed for facing in the direction of rotation, the second leading face having one or more second leading surfaces. When each pair of lifter bars is mounted on the shell, the first trailing face and the second leading face at least partially define a pocket therebetween in which at least a part of the engaged portion of the load is at least partially retainable as the part is raised above the disengaged portion until the second leading surface is located in a predetermined release position, at which the part has substantially exited the pocket under the influence of gravity.

In another aspect, when the second leading surface is in the release position, the second leading surface is tilted downwardly toward the axis to define an angle relative to the horizontal substantially greater than the angle of repose of the load.

In another of its aspects, the invention provides a grinding mill for grinding a charge including a number of ore pieces. The grinding mill includes a shell rotatable about an axis thereof in a direction of rotation in which a load is receivable, the load including the charge, and a number of lifter bars, each lifter bar being mounted to the shell on an inner surface thereof and positioned around an inner circumference of the shell at least partially defined by the inner surface. Each lifter bar includes a leading face formed for facing in the direction of rotation, the leading face having one or more leading surfaces, and a trailing face, formed for facing in a direction opposite to the direction of rotation. Each lifter bar is spaced apart from a preceding lifter bar thereto by a predetermined distance, the preceding lifter bar being positioned in the direction of rotation relative to the lifter bar. Each lifter bar and the preceding lifter bar comprise a pair of lifter bars, being a trailing and a leading lifter bar respectively in each pair. The leading face of each trailing lifter bar is positioned relative to the trailing face of the leading lifter bar to at least partially define a pocket therebetween in which at least a part of an engaged portion of the load is at least partially retainable as the part is raised above a disengaged portion of the load, the part being at least partially retainable in the pocket until the leading surface is located in a predetermined release position, at which the part has substantially exited the pocket under the influence of gravity.

In another aspect, each leading surface extends between a leading outer end, at which the leading surface is proximal to the shell, and a leading inner end, positioned between the shell and the axis, and each leading surface is in the release position when the leading inner end is lower than the leading outer end so that each leading surface is positioned relative to the horizontal at an angle greater than the angle of repose of the load.

In yet another aspect, each leading surface is positioned at a preselected leading surface angle relative to a leading face tangent therefor, the leading surface tangent being tangential to the shell and orthogonal to a first radius through the axis and the leading inner end.

In another aspect, the preselected leading surface angle is an acute angle.

In another of the invention's aspects, upon each lifter bar being mounted to the shell, each lifter bar has an initial height relative to the inner surface of the shell, the initial height being a radial distance from the inner surface to a top surface of the lifter bar, and the initial heights of selected ones of the lifter bars are less than the initial heights of selected others of the lifter bars.

### BRIEF DESCRIPTION OF THE DRAWINGS

The invention will be better understood with reference to the attached drawings, in which:

FIG. 1A is a longitudinal cross-section of an embodiment of a grinding mill of the invention with a charge therein;

FIG. 1B is a simplified cross-section of the grinding mill of FIG. 1A drawn at a larger scale, showing an embodiment of a lifter bar assembly of the invention therein;

FIG. 1C is a simplified cross-section of the grinding mill of FIG. 1A in which a part of a lifted portion of the charge is illustrated as being lifted by the lifter bar assembly;

FIG. 1D is a portion of the cross-section of the grinding mill of FIG. 1C, drawn at a larger scale;

FIG. 1E is an alternative simplified cross-section of the grinding mill of FIG. 1A, drawn at a smaller scale;

FIG. 2A is a cross-section of a portion of the grinding mill of FIG. 1D, drawn at a larger scale;

FIG. 2B is a cross-section of a portion of an alternative embodiment of the grinding mill of the invention;

FIG. 2C is a cross-section of the grinding mill of FIG. 2B, drawn at a smaller scale;

FIG. 2D is a portion of a cross-section of an alternative embodiment of the lifter bar assembly of the invention, drawn at a larger scale;

FIG. 3 is a cross-section of a portion of another embodiment of the grinding mill of the invention;

FIG. 4 is a cross-section of another embodiment of a lifter bar of the invention, drawn at a smaller scale;

FIG. 5 is a cross-section of another embodiment of a lifter bar of the invention; and

FIG. 6 is a cross-section of another alternative embodiment of the lifter bar of the invention.

### DETAILED DESCRIPTION

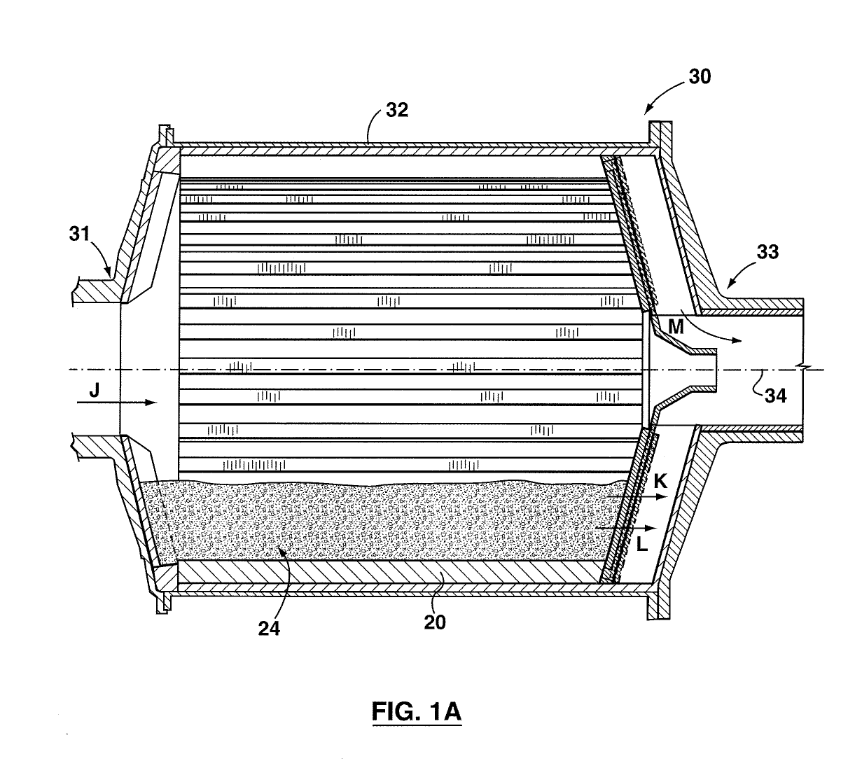

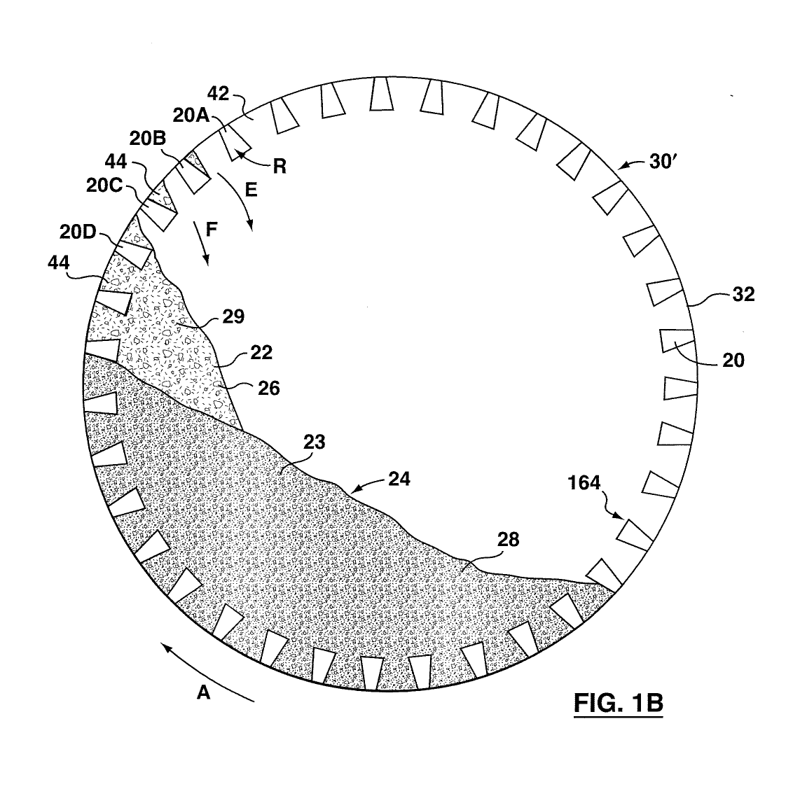

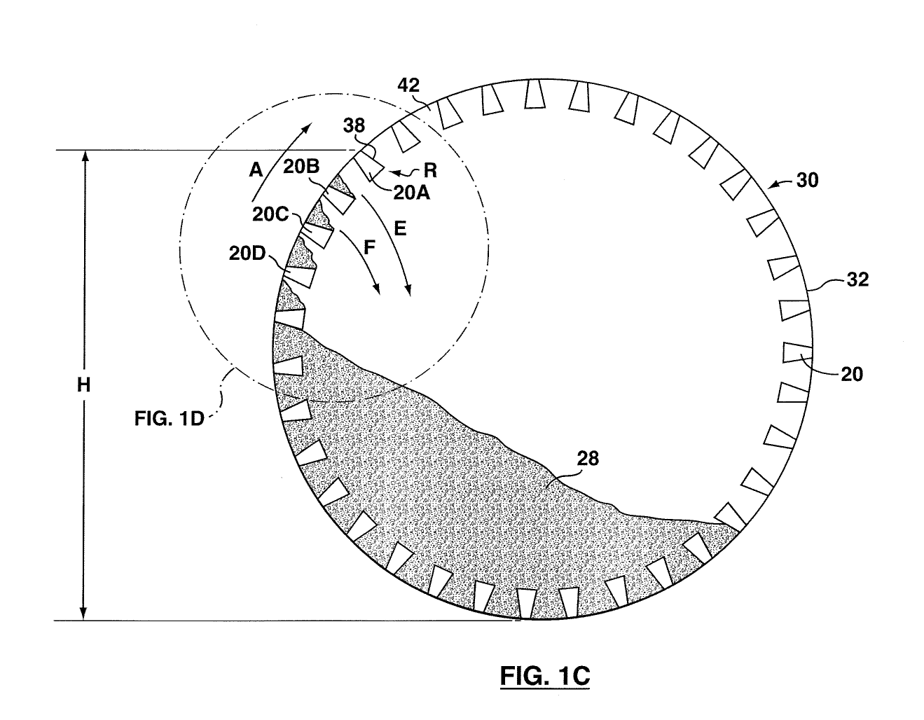

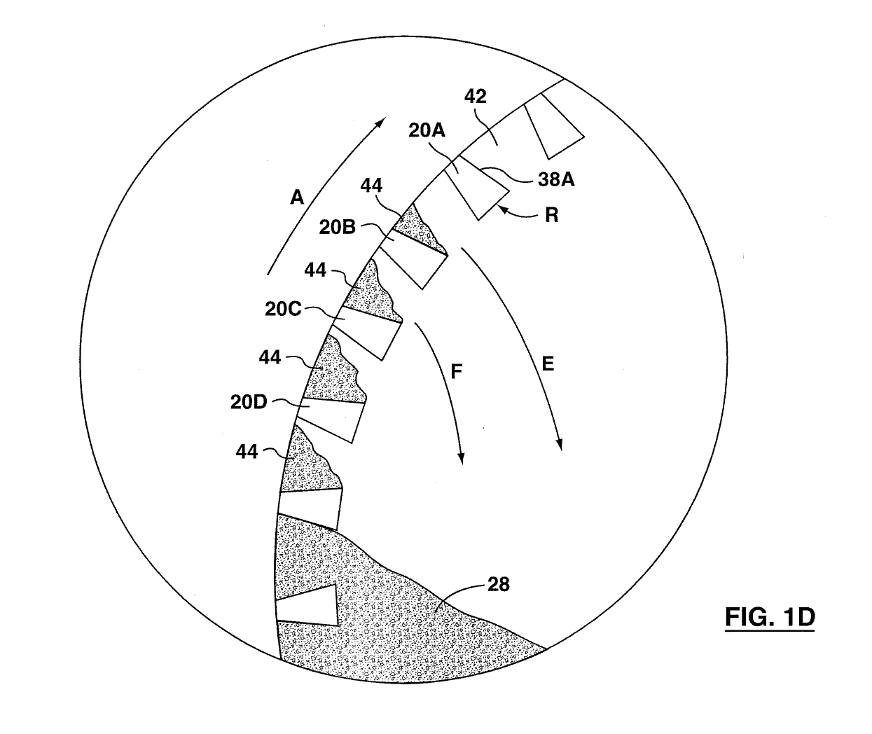

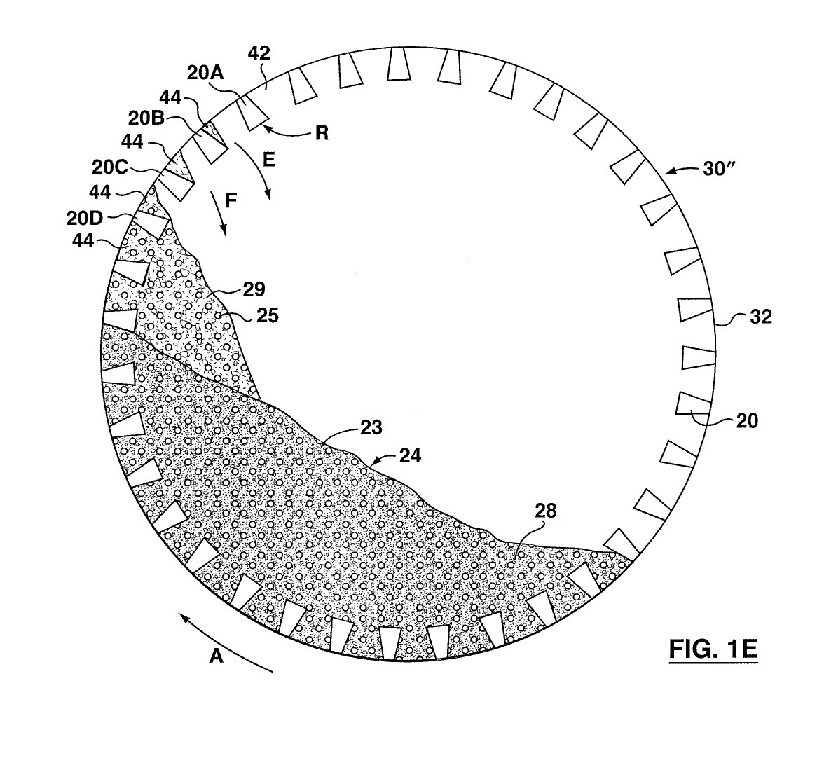

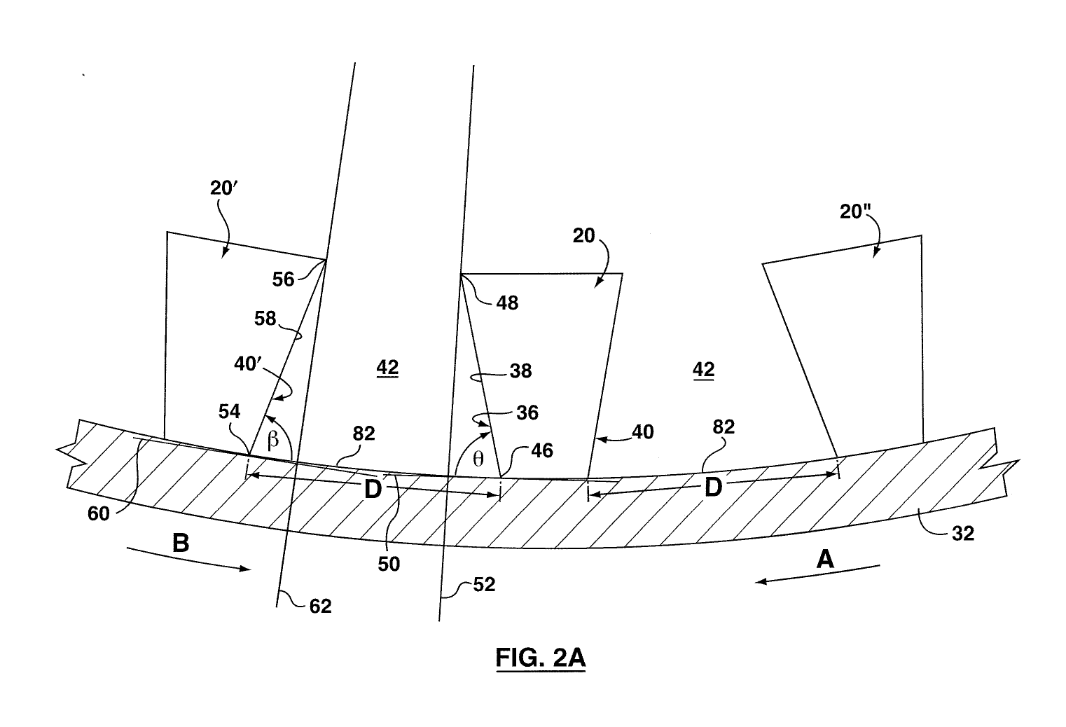

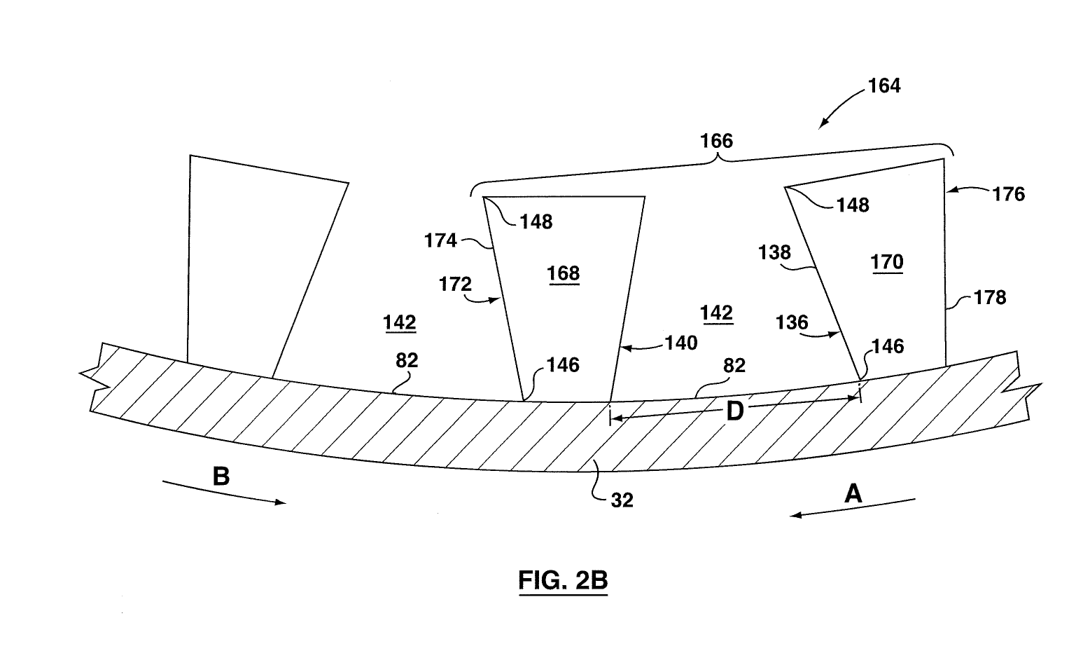

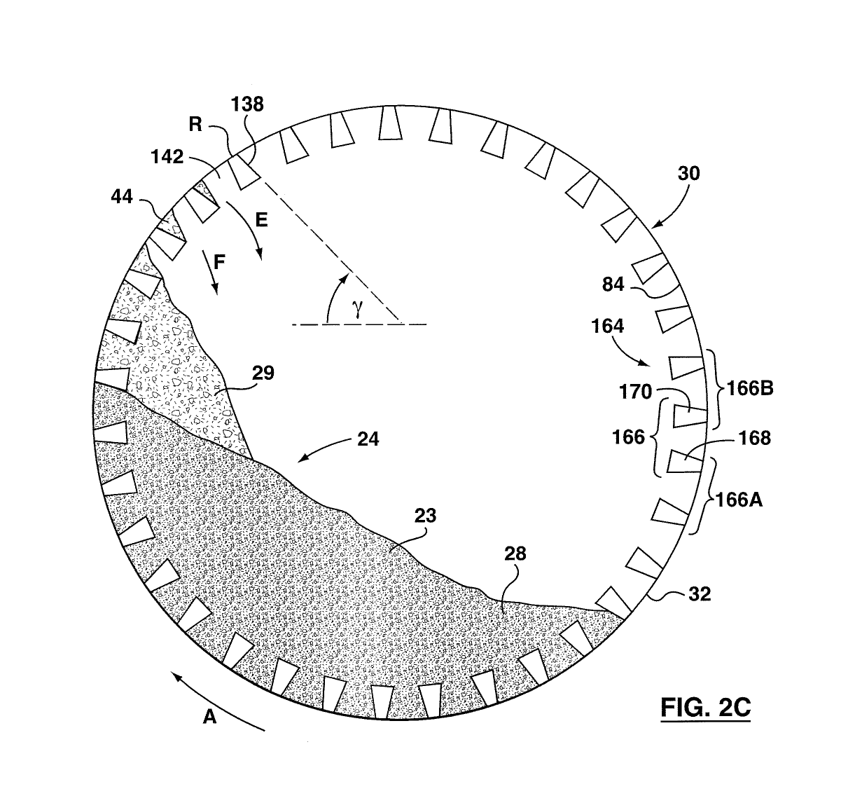

In the attached drawings, like reference numerals designate corresponding elements throughout. Reference is first made to FIGS. 1A-2B to describe an embodiment of a lifter bar of the invention referred to generally by the numeral 20. The lifter bar 20 is for lifting an engaged portion 22 of a load 24 including a number of ore pieces 26 above a disengaged portion 28 of the load 24 in a grinding mill 30. The grinding mill 30 includes a shell 32 rotatable about an axis 34 thereof (FIG. 1A) in a direction of rotation, e.g., as indicated by arrow “A” in FIG. 1B. In one embodiment, the lifter bar 20 preferably includes a leading face 36 formed for facing in the direction of rotation. It is also preferred that the leading face 36 has one or more leading surfaces 38, as will be described. The lifter bar 20 preferably also includes a trailing face 40 formed for facing in a direction opposite to the direction of rotation (indicated by arrow “B” in FIG. 2A), as will also be described. As can be seen in FIG. 2A, the lifter bar 20 is mountable on the shell 32 at a predetermined distance “D” from a trailing face 40′ of a preceding lifter bar 20′, the preceding lifter bar 20′ being mounted on the shell in the direction of rotation relative to the lifter bar 20. When the lifter bar 20 and the preceding lifter bar 20′ are mounted on the shell 32, the leading face 36 is positioned relative to the trailing face 40′ of the preceding lifter bar 20′ to at least partially define a pocket 42 therebetween in which at least a part 44 (FIGS. 1B-1E) of the engaged portion 22 of the load 24 is at least partially retainable as the part 44 is being raised above the disengaged portion 28, until the leading surface 38 is located in a predetermined release position (identified at “R” in FIGS. 1B-1E and 2C), at which the part 44 has substantially exited the pocket 42 under the influence of gravity (FIGS. 1B-1E).

It will be understood that, for the purposes hereof, the grinding mill may be an autogenous grinding mill or a semi-autogenous grinding mill. It will also be understood that, for the purposes hereof, the load 24 may consist of a charge 23 alone (i.e., if the mill is an autogenous grinding mill), or the load 24 may consist of the charge 23 and grinding media 25 (i.e., if the mill is a semi-autogenous mill). It will also be understood that the mill 30 illustrated in FIG. 1A may be either an autogenous mill or a semi-autogenous grinding mill. As can be seen in FIG. 1A, the charge 23 is introduced at a feed end 31 of the shell 32 (as indicated by arrow “J” in FIG. 1A), and the comminuted charge 23 exits the shell 32 at a discharge end 33 thereof (as indicated by arrows “K”, “L”, and “M” in FIG. 1A). An autogenous mill 30′ is illustrated in FIG. 1B, and a semi-autogenous mill 30″ is illustrated in FIG. 1E. The description of the invention as illustrated in FIGS. 1A-2C is equally applicable to autogenous and semi-autogenous grinding mills.

Those skilled in the art will appreciate that the ore pieces 26 have an initial size distribution, upon introduction of the charge 23 into the shell 32 at the feed end 31. As is known, upon the charge 23 exiting the shell 32 at the discharge end 33, the ore pieces 26 have a different size distribution (i.e., different from the initial size distribution, as required for the particular application) due to the comminution to which the charge 23 has been subjected in the shell 32.

Those skilled in the art would appreciate that the direction of rotation may be clockwise or counterclockwise. It will be understood that the direction of rotation as illustrated in FIGS. 1B-2A is exemplary only.

For clarity of illustration, a number of the lifter bars 20 are identified as 20A-20D in FIGS. 1B-1E. As can be seen in FIGS. 1B, 1C, and 1E, the lifter bars 20 which have passed the 3 o'clock position are buried under the load 24 as the shell 32 rotates in the direction of rotation, indicated by arrow “A” in FIGS. 1B-2A. The lifter bars 20A-20D are shown in FIG. 1B in a position where they are beginning to be buried under the load 24. It can be seen that, due to the movement of the lifter bars 20 in the direction of rotation, the engaged portion 22 of the load 24 is engaged by the lifter bars 20. It will be understood that, for clarity of illustration, a balance 29 of the engaged portion 22 is omitted from FIG. 1C (i.e., the balance 29 consisting of the engaged portion 22 other than the parts 44), except for the parts 44 positioned on the lifter bars.

In FIG. 1D, the lifter bars 20A-20D are shown generally between the 9 o'clock and 11 o'clock positions, drawn at a larger scale than in FIG. 1C. The lifter bar 20A is shown in the release position R in FIGS. 1C and 1D. As noted above, when the lifter bar 20A is in the release position R, the leading surface 38 is positioned to define an angle greater than an angle of repose of the load 24. (In FIG. 1D, the leading surface of the lifter bar 20A is identified as 38A.) As can be seen, for instance, in FIG. 1C, when the lifter bar 20A is in the release position R, the part 44 has been released, and the leading surface 38 of the lifter bar 20A is substantially at a predetermined height “H” above the bottom of the shell.

In FIG. 1D, the lifter bars 20A-20C are shown in positions where the parts 44 are retained in pockets 42 (FIG. 2A) defined between each lifter bar 20 and the lifter bars adjacent thereto respectively. For example, pockets 42 are defined respectively between lifter bars 20 and 20′, and also between lifter bars 20 and 20″ (FIG. 2A).

Those skilled in the art will appreciate that, until the release position R is reached, certain portions of the part 44 retained in the pocket 42 fall out of the pockets 42 as the pocket is raised. For purposes of illustration, this piecemeal and gradual movement of the part 44 out of the pocket 42 is illustrated in FIGS. 1C and 1D in a simplified manner, in the absence of the balance 29 of the engaged portion 22. As indicated by arrows “E” and “F” in FIGS. 1C and 1D, portions (not shown separately) of the parts 44 positioned on lifter bars 20B and 20C respectively fall out of the pockets 42 partially defined thereby as the shell 32 rotates. When the lifter bar is in the release position R, the part 44 completes exiting the pocket 42 at least partially defined by the leading face 36 thereof. It will be understood that the drawings are simplified in this regard. In practice, the movement of portions out of the parts 44 is only part of the cataracting or tumbling movement of the engaged portion 22, and is not readily defined as distinct from the simultaneous movement of the balance 29.

In one embodiment, and as can be seen in FIG. 2A, the leading face 36 extends between a leading outer end 46 positioned proximal to the shell 32 and a leading inner end 48 positioned between the leading outer end and the axis 34 (not shown in FIG. 2A), when the lifter bar 20 is mounted on the shell 32. The leading surface 38 preferably extends from the leading inner end 48 toward the leading outer end 46. When the lifter bar 20 is mounted on the shell 32, the leading surface 38 is located at a preselected leading surface angle θ relative to a leading surface tangent 50 therefor, the leading surface tangent 50 being tangential to the shell 32 and substantially orthogonal to a first radius 52 through the axis 34 and the leading inner end 48 (FIG. 2A). As can be seen, for example, in FIG. 2A, the leading surface angle θ preferably is an acute angle. Because the leading surface 38 is positioned at an acute angle relative to the leading surface tangent 50, the leading surface 38 retains the part 44 thereon up to a greater height than the prior art lifter bars.

In one embodiment, the trailing face 40 extends between a trailing outer end 54 positioned proximal to the shell 32 when the lifter bar 20 is mounted on the shell 32, and a trailing inner end 56 positioned between the trailing outer end 54 and the axis 34. Preferably, the trailing face 40 includes one or more trailing surfaces 58 extending from the trailing inner end 56 toward the trailing outer end 54, as will be described. When the lifter bar 20 is mounted on the shell 32, the trailing surface 58 preferably is positioned at a preselected trailing surface angle β relative to a trailing surface tangent 60 therefor, the trailing surface tangent 60 being tangential to the shell and substantially orthogonal to a second radius 62 through the axis 34 and the trailing face inner end 56.

The invention also includes a lifter bar assembly 164, partially illustrated in FIG. 2B. In one embodiment, the lifter bar assembly 164 (FIGS. 2B, 2C) preferably includes a number of pairs 166 of the lifter bars 20. Preferably, each pair 166 of lifter bars 20 includes a leading lifter bar 168 mountable on the shell 32 and having a first trailing face 140 formed for facing away from the direction of rotation (FIG. 2B). The pair 166 preferably also includes a trailing lifter bar 170 mountable on the shell 32 at the predetermined distance D (FIG. 2B) from the first trailing face 140 of the leading lifter bar 168, positioned relative to the leading lifter bar 168 in a direction opposite to the direction of rotation (indicated by arrow “B” in FIG. 2B). As can be seen in FIG. 2B, the trailing lifter bar 170 preferably includes a second leading face 136 formed for facing in the direction of rotation. Preferably, the second leading face 136 includes one or more second leading surfaces 138, as will be described. When each pair 166 of lifter bars 20 is mounted on the shell 32, the first trailing face 140 and the second leading face 136 at least partially define a pocket 142 therebetween in which at least the part 44 of the engaged portion 22 of the load 24 is at least partially retainable as the part 44 is raised above the disengaged portion 28, until the second leading surface 138 is located in the predetermined release position R (FIG. 2C). When the second leading surface 138 is in the release position R, the part 44 has substantially exited the pocket 42 under the influence of gravity.

Preferably, when the second leading surface 138 is in the release position R, the second leading surface 138 is tilted downwardly toward the axis 34 to define an angle γ relative to the horizontal substantially greater than the angle of repose of the load 24 (FIG. 2C). The angle of repose is defined in the Academic Press Dictionary of Science and Technology (1992) as:
the steepest angle of a surface at which a mass of loose or fragmented material will remain standing in a pile on a surface, rather than sliding or crumbling away . . .

For the purposes hereof, “angle of repose” is defined as set out above. As is known in the art, the angle of repose of the load varies according to a number of factors. Those skilled in the art would be aware of the factors. The relevant characteristics of the load, and of the grinding mill, would vary from one mine to another. For instance, for a particular mine, the angle of repose of the load may vary over relatively short time periods due to variations in physical characteristics of the ore being mined and added into each mill, or other variations, e.g., variations in size distribution in the feed to the mill. It will be appreciated by those skilled in the art that the specific parameters of any particular lifter bar of the depend on a number of factors, i.e., many factors other than certain characteristics of the load may be relevant. The final design of a lifter bar of the invention (e.g., the preselected leading surface angle θ, and the preselected trailing surface angle β) may represent a compromise among various factors. In addition, although the preselected leading face angle θ and the preselected trialing face angle β are illustrated in the drawings as being substantially the same (i.e., mirror images of each other), it will be understood that these angles may substantially differ from each other.

It will be understood that, in most cases, the mill shells rotate relatively rapidly. As is known, the determination of the rotation speed is subject to a number of factors. Those skilled in the art will appreciate that, because the shell rotates relatively rapidly about its axis 34, and also because the part 44 exits the product 42 under the influence of gravity, it is possible that, if the pocket 42 were appropriately formed, the part 44 could be retained in the pocket 42 so that the pocket 44 is not fully emptied when the lifter bars 20 at least partially defining the pocket 44 are again buried under the load. Preferably, the second leading surface 136 is positioned in an optimum position. As noted above, due to conditions which may vary over time, the optimum position may be, for instance, determined based on averages of anticipated factors. In general, the optimum position is one in which the part 44 is retainable in the pocket 42 until the pocket 42 is moved to the highest position possible before release of the part 44 under the influence of gravity. However, because the shell rotates rapidly, the part 44 preferably is released in time to permit sufficient time to empty the pocket before the lifter bars at least partially defining such pocket are buried again by the load.

In one embodiment, and as can be seen in FIG. 2B, the leading lifter bar 168 preferably also includes a first leading face 172 having one or more first leading surfaces 174. The trailing lifter bar 170 preferably also includes a second trailing face 176. Each of the first and second trailing faces 140, 176 includes one or more trailing surfaces 178 respectively.

Preferably, each of the first and second leading faces 172, 136 extends between a respective leading outer end 146 positioned proximal to the shell 32 and a respective leading inner end 148 positioned between the leading outer end 146 therefor and the axis 34, when the lifter bar assembly 164 is mounted on the shell 32. The second leading surface 138 preferably extends from the leading inner end 148 therefor toward the leading outer end 146 therefor, and the second leading surface 138 is in the release position R when the leading inner end 148 therefor is lower than the leading outer end 146 therefor such that the second leading surface 138 is positioned at an angle relative to the horizontal substantially greater than the angle of repose of the load (FIG. 2C).

In another embodiment, and as can be seen in FIG. 1A, the invention provides the grinding mill 30 for grinding the charge 23 which includes the ore pieces 26 therein. Preferably, the grinding mill 30 includes the shell 32 rotatable about the axis 34 in which the load 24 is receivable, the load 24 including the charge 23, and a number of lifter bars 20. It is preferred that each lifter bar 20 is mounted to the shell 32 on an inner surface 82 thereof and positioned around an inner circumference 84 (FIG. 2C) of the shell 32 at least partially defined by the inner surface 82 (FIGS. 2A, 2B). As described above, each lifter bar 20 includes the leading face 36 formed for facing in the direction of rotation, and including one or more leading surfaces 38, and a trailing face 40, formed for facing in a direction opposite to the direction of rotation. Each lifter bar 20 is spaced apart from the preceding lifter bar 20′ by the predetermined distance D, the preceding lifter bar 20′ being positioned in the direction of rotation relative to the lifter bar 20. Preferably, each lifter bar 20 and the preceding lifter bar 20′ thereto comprise a pair 166 of lifter bars 20, being a trailing and a leading lifter 170, 168 bar respectively. The leading face of each trailing lifter bar 170 preferably is positioned relative to the trailing face of the leading lifter bar 168 to at least partially define the pocket 42 therebetween in which at least the part 44 of an engaged portion of the load 24 is at least partially retainable as the part 44 is raised above a disengaged portion of the load 24, until the leading surface 38 is located in the predetermined release position R, at which the part 44 has substantially exited the pocket 42 under the influence of gravity.

It is also preferred that each pair 166 of lifter bars overlaps with adjacent ones of the pairs of lifter bars 20 mounted on the inner surface 82. (For convenience, adjacent pairs are identified as 166A and 166B in FIG. 2C.) The adjacent pairs includes an anterior overlapping pair (identified as 166A in FIG. 2C) positioned adjacent to the trailing lifter bar 170 in the central one 166 of the pairs, in the direction of rotation relative thereto, and a following overlapping pair (identified as 166B in FIG. 2C) positioned adjacent to the leading lifter bar 168 in the central one 166 of the pairs in a direction opposite to the direction of rotation relative thereto. As can be seen in FIG. 2C, in each central one 166 of the pairs of lifter bars 20, the leading lifter bar 168 thereof serves as the trailing lifter bar in the anterior overlapping pair 166A thereto, and the trailing lifter bar 170 thereof serves as the leading lifter bar in the following overlapping pair 166B thereto.

In one embodiment, the grinding mill 30 preferably is autogenous. In an alternative embodiment, the grinding mill 30 preferably is semi-autogenous.

As can be seen in FIG. 2A, the leading surface 38 of each lifter bar 20 preferably extends between the leading outer end 46, at which the leading surface 38 is proximal to the shell 32, and a leading inner end 48, positioned between the shell 32 and the axis 34. It is preferred that the leading surface is in the release position R when the leading inner end 48 is lower than the leading outer end 46 so that the leading surface 38 is positioned relative to the horizontal at an angle greater than the angle of repose of the load.

In one embodiment, the leading surface 38 is positioned at the preselected leading surface angle θ relative to the leading surface tangent 50 therefor (FIG. 2A), the leading surface tangent 50 being tangential to the shell and orthogonal to the first radius 52 through the axis 34 and the leading inner end 48. Preferably, the preselected leading surface angle θ is an acute angle.

Those skilled in the art will appreciate that, in practice, wear plates (not shown in FIGS. 1B-2A) are mounted on the shell between the lifter bars. It will be understood that the wear plates are omitted from FIGS. 1B-2A for clarity of illustration. The lifter bars may be positioned (for instance, in part) on wear plates. For the purposes hereof, it will be understood that the inner surface may include wear plates (not shown).

Preferably, the lifter bars are made of any material which is suitably tough and resilient, e.g., for certain applications, a suitable polymeric material. Those skilled in the art would be aware of suitable materials for a particular grinding application. For example, for certain applications (e.g., “wet” grinding in autogenous or semi-autogenous mills), rubber has been found to be a suitable material. However, those skilled in the art will appreciate that, in certain other applications (e.g., “dry” grinding), the lifter bars are preferably made of steel. It will be understood that the lifter bar of the invention described herein may be used in any type of grinding mill, in any type of application, e.g., whether dry or wet grinding.

In one application, each lifter bar 20 preferably extends about 21 inches (approximately 550 mm.) inwardly from the shell 32 when first installed (i.e., before being subjected to wear). However, because (as noted above) each mill is designed according to a number of factors, it will be understood by those skilled in the art that the height of the lifter bars 20 may vary significantly, depending on the mill and the application. The lifter bars 20 preferably are attached to the shell 32 using any suitable means, as are known to those skilled in the art.

### INDUSTRIAL APPLICABILITY

In use, when the lifter bars 20A-20D are between approximately the 4 o'clock and the 8 o'clock positions, the lifter bars 20A-20D are buried beneath the load 24, due to its cataracting or tumbling movement as the shell 32 rotates in the direction of rotation. As the lifter bars 20A-20D are moved upwardly from approximately the 8 o'clock position to approximately the 10 o'clock position, the lifter bars 20A-20D at least partially assist in lifting the engaged portion 22 above the disengaged portion 28 of the load 24 (FIG. 1B). As can be seen in FIG. 1C, the part 44 is carried slightly higher than the balance 29 of the engaged portion 22, i.e., the part 44 is retained in the pocket 42 until the pocket 42 is positioned at an angle above the horizontal approximately equal to the angle of repose of the load.

It is believed that the configuration of the pocket 42 defined between the adjacent lifter bars tends to cause more of the lifted portion of the load to remain between the lifter bars above about the 9 o'clock position than would otherwise be the case. In particular, because the part 44 rests on the leading surface 38, the position of the leading surface 38 at an acute angle relative to the leading surface tangent 50 results in the part 44 being retained on the leading surface 38 to a relatively high height, compared to the prior art lifter bars, before the part is released. This tends to result in higher productivity because a significant part of the ore is lifted higher before its release (i.e., than would be the case if the prior art lifter bars were used), so that there is somewhat more kinetic energy released when (in an autogenous grinding mill) the raised ore falls on the lower ore in the load.

In an autogenous mill, increased maximum impact is achieved using the lifter bars of the invention herein, resulting in more efficient comminution of the charge 23. In a semi-autogenous mill, both increased impact and increased attrition are achieved using the lifter bars of the invention herein, resulting in more efficient comminution of the charge 23.

Additional embodiments of the invention are illustrated in FIGS. 2D-6. In FIGS. 2D-6, elements are numbered so as to correspond to like elements shown in FIGS. 1A-2A.

Another embodiment of the lifter bars 320 is shown in FIG. 2D. As can be seen in FIG. 2D, each lifter bar 320 includes leading and trailing inserts 385, 386. The leading and trailing inserts preferably provide relatively hard surfaces at the leading and trailing faces respectively. For instance, the inserts 385, 386 may be made of any suitable steel.

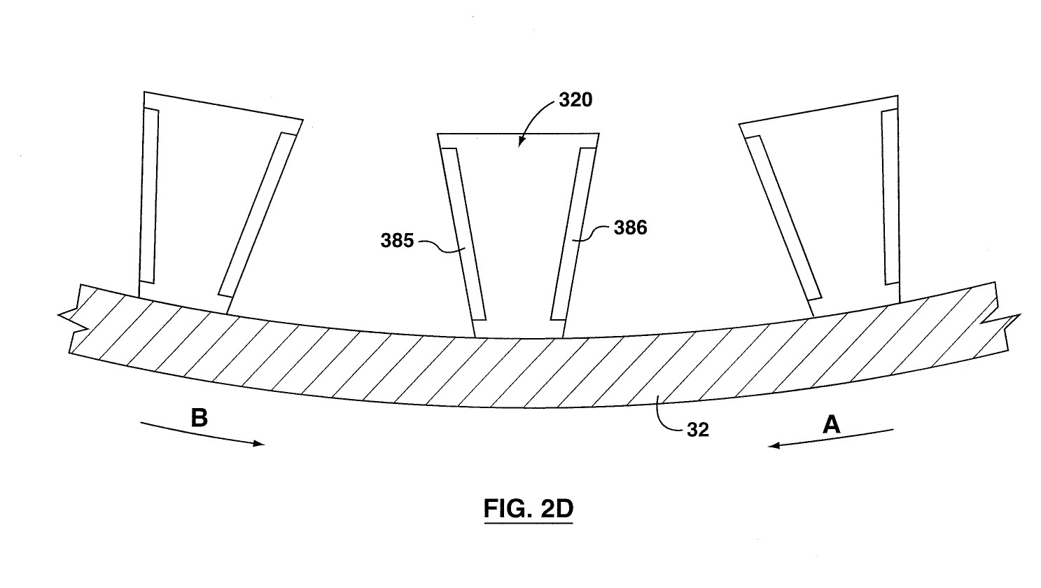

Another embodiment of the lifter bar assembly 464 of the invention is shown in FIG. 3. Preferably, the lifter bar assembly 464 includes a first lifter bar 488 having a first predetermined height 489 and a second lifter bar 490 having a second predetermined height 491. In one embodiment, the second predetermined height 491 preferably is approximately one-half of the first predetermined height 489. As can be seen in FIG. 3, a third lifter bar 488′ positioned to follow the second lifter bar 490 has a leading face 472′. The leading face 472′ of the lifter bar 488′ is believed to retain a relatively significant part (identified as 444 in FIG. 3) of the portion of the load engaged by the first lifter bar 488 when it is in the region between approximately the 9 o'clock and 10 o'clock positions (i.e., where the shell is rotated in the clockwise direction), so that part of the engaged portion is lifted above the disengaged portion of the load. (For clarity of illustration, the load is omitted from FIG. 3.) In addition, it is believed that the shorter second lifter bar 490 has the advantage that it offers less of an obstacle to the part lifted by the leading face 472′ immediately following the lifter bar 490, when the part 444 is first engaged by the lifter bar 488′. It is also believed that the reduced height of the second lifter bar represents a sort of compromise between the competing goals of (i) retaining a part of the load between the lifter bars while it is raised, and (ii) quickly releasing the raised part of the load, to achieve maximum impact.

In addition, having lifter bars 488, 490 with different heights upon the initial installation thereof results in only half of the lifter bars requiring replacement at any one time, i.e., when the initially shorter lifter bars are sufficiently worn to require replacement. This can minimize the downtime required at any one time, for replacement of lifter bars.

Upon each lifter bar 488, 489 being mounted to the shell 32, each lifter bar 488, 489 has an initial height 489, 491 respectively relative to the inner surface 482 of the shell 32, the initial height 492 being a radial distance from the inner surface to an inner surface 492 of the lifter bar 488, 489. The initial heights of selected ones 489 of the lifter bars are less than the initial heights of selected others 488 of the lifter bars.

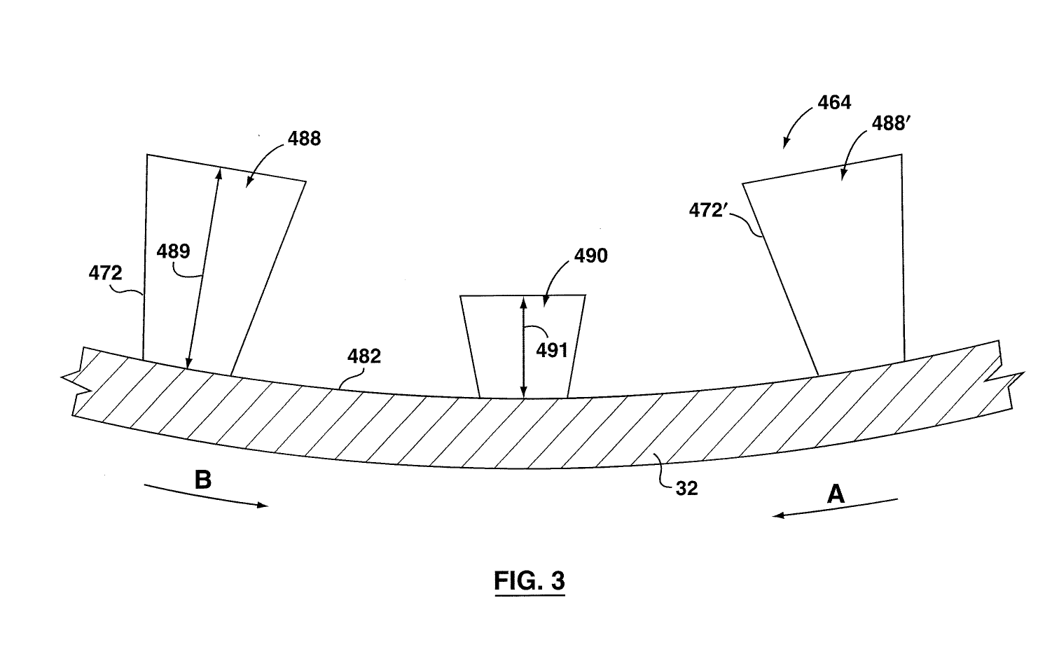

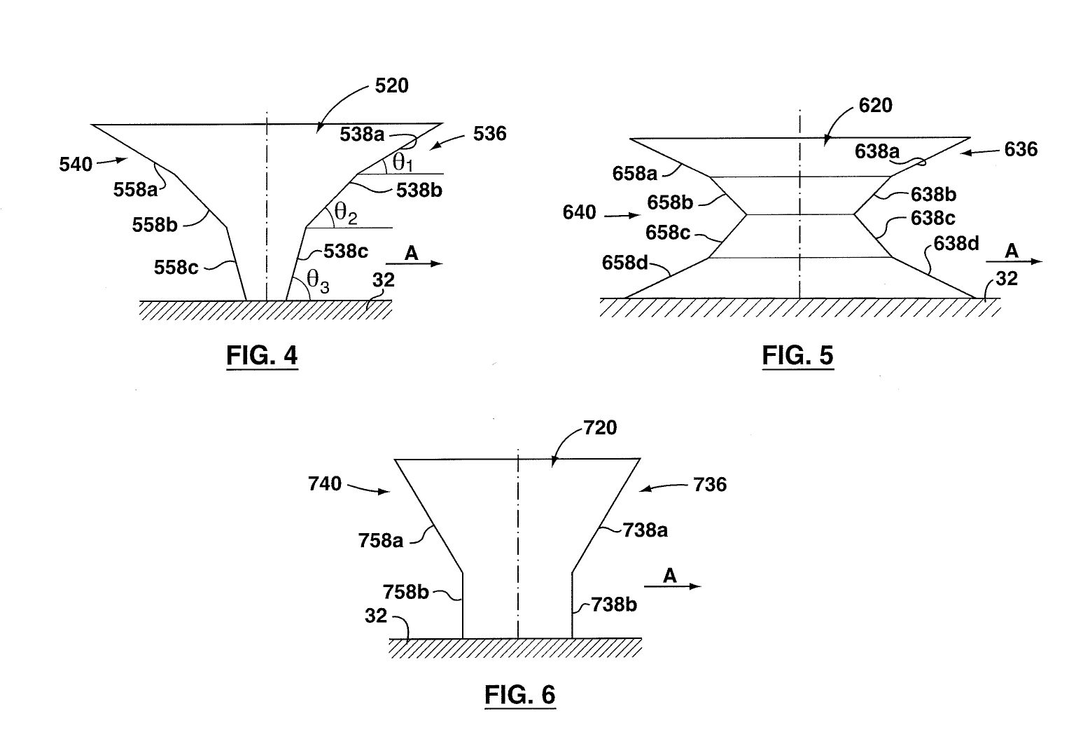

Another alternative embodiment of a lifter bar 520 of the invention is disclosed in FIG. 4. As can be seen in FIG. 4, the leading face 536 of the lifter bar 520 includes a number of leading surfaces 538a, 538b, 538c which are positioned at different angles (θ₁ and θ₂ and θ₃ respectively) relative to a tangent to the shell 32 at the point where the leading face 536 and the shell 32 meet. It is also preferred that the trailing face 540 includes trailing surfaces 558a, 558b, and 558c that correspond to the segments 538a, 538b, and 538c respectively, and are positioned accordingly.

In another alternative embodiment shown in FIG. 5, a lifter bar 620 of the invention includes leading and trailing faces 636, 640 with four substantially planar surfaces each respectively. The surfaces 638a-638d comprise the leading face 636, and the trailing surfaces 658a-658d comprise the trailing face 640. Preferably, the trailing surfaces 658a-658d correspond to the leading surfaces 638a-638d respectively.

Another embodiment of a lifter bar 720 of the invention is illustrated in FIG. 6. In this embodiment, a leading face 736 thereof includes first and second surfaces 738a, 738b, and a trailing face 740 includes first and second surfaces 758a, 758b.

It will be understood that the surfaces of the leading and trailing faces are shown as being substantially planar for convenience. Those skilled in the art will appreciate that, due to wear after installation, the lifter bars and the leading and trailing faces, will in practice have surfaces that are not necessarily planar. The lifter bars illustrated in the drawings are shown as formed upon initial installation, i.e., before they are subjected to wear.

It will be appreciated by those skilled in the art that the invention can take many forms, and that such forms are within the scope of the invention as described above. The foregoing descriptions are exemplary and their scope should not be limited to the preferred versions contained herein.

We claim:

1. A lifter bar for lifting an engaged portion of a load comprising a plurality of ore pieces above a disengaged portion of the load in a grinding mill comprising a shell rotatable about an axis thereof in a direction of rotation, the lifter bar comprising:
a leading face formed for facing in the direction of rotation, the leading face comprising at least one leading surface;
a trailing face, formed for facing in a direction opposite to the direction of rotation;
the lifter bar being mountable on the shell located at a predetermined distance from a trailing face of a preceding lifter bar, the preceding lifter bar being positioned relative to the lifter bar in the direction of rotation; and
when the lifter bar and the preceding lifter bar are mounted on the shell, the leading face is positioned relative to the trailing face of the preceding lifter bar to at least partially define a pocket therebetween in which at least a part of the engaged portion of the load is at least partially retainable as the part is raised above the disengaged portion, until said at least one leading surface is located in a predetermined release position, when the part completes exiting the pocket under the influence of gravity.

2. A lifter bar according to claim 1 in which:
the leading face extends between a leading outer end positioned proximal to the shell and a leading inner end positioned between the leading outer end and the axis, when the lifter bar is mounted on the shell;
said at least one leading surface extends from the leading inner end toward the leading outer end; and
when the lifter bar is mounted on the shell, said at least one leading surface is located at a preselected leading surface angle relative to a leading surface tangent therefor, the leading surface tangent being tangential to the shell and substantially orthogonal to a first radius through the axis and the leading inner end.

3. A lifter bar according to claim 2 in which the preselected leading surface angle is an acute angle.

4. A lifter bar according to claim 1 in which:
the trailing face extends between a trailing outer end positioned proximal to the shell when the lifter bar is mounted on the shell, and a trailing inner end positioned between the trailing outer end and the axis; and
the trailing face comprises at least one trailing surface extending from the trailing inner end toward the trailing outer end.

5. A lifter bar according to claim 4 in which, when the lifter bar is mounted on the shell, said at least one trailing surface is positioned at a preselected trailing surface angle relative to a trailing surface tangent therefor, the trailing surface tangent being tangential to the shell and substantially orthogonal to a second radius through the axis and the trailing face inner end.

6. A lifter bar assembly for lifting an engaged portion of a load comprising a plurality of ore pieces above a disengaged portion of the load in a grinding mill comprising a shell rotatable about an axis thereof in a direction of rotation, the lifter bar assembly comprising:
a plurality of pairs of lifter bars;
each said pair of said lifter bars comprising:
a leading lifter bar mountable on the shell and comprising a first trailing face formed for facing away from the direction of rotation;
a trailing lifter bar mountable on the shell at a predetermined distance from the first trailing face of the leading lifter bar, the trailing lifter bar being positioned relative to the leading lifter bar in a direction opposite to the direction of rotation, the trailing lifter bar comprising a second leading face formed for facing in the direction of rotation;
the second leading face comprising at least one second leading surface; and
when each said pair of lifter bars is mounted on the shell, the first trailing face and the second leading face at least partially define a pocket therebetween in which at least a part of the engaged portion of the load is at least partially retainable as the part is raised above the disengaged portion, until said at least one second leading surface is located in a predetermined release position, when the part completes exiting the pocket under the influence of gravity.

7. A lifter bar assembly according to claim 6 in which, when said at least one second leading surface is in the release position, said at least one second leading surface is tilted downwardly toward the axis to define an angle relative to the horizontal substantially greater than the angle of repose of the load.

8. A lifter bar assembly according to claim 6 in which:
the leading lifter bar additionally comprises a first leading face comprising at least one first leading surface;
the trailing lifter bar additionally comprises a second trailing face; and
each of the first and second trailing faces comprises at least one trailing surface respectively.

9. A lifter bar assembly according to claim 8 in which:
each of said first and second leading faces extends between a respective leading outer end positioned proximal to the shell and a respective leading inner end positioned between the leading outer end therefor and the axis, when the lifter bar assembly is mounted on the shell;
said at least one second leading surface extends from the leading inner end toward the leading outer end therefor; and
said at least one second leading surface is in the release position when the leading inner end is lower than the leading outer end therefor such that said at least one second leading surface is positioned at an angle relative to the horizontal substantially greater than the angle of repose of the load.

10. A grinding mill for grinding a charge comprising a plurality of ore pieces, the grinding mill comprising:
a shell rotatable about an axis thereof in a direction of rotation in which a load is receivable, the load comprising the charge;
a plurality of lifter bars, each said lifter bar being mounted to the shell on an inner surface thereof and positioned around an inner circumference of the shell at least partially defined by the inner surface;
each said lifter bar comprising:
a leading face formed for facing in the direction of rotation, the leading face comprising at least one leading surface;
a trailing face, formed for facing in a direction opposite to the direction of rotation;
each said lifter bar being spaced apart from a preceding lifter bar thereto by a predetermined distance, the preceding lifter bar being positioned in the direction of rotation relative to the lifter bar;
each said lifter bar and the preceding lifter bar comprising a pair of said lifter bars, being a trailing and a leading lifter bar respectively in said pair; and
the leading face of each said trailing lifter bar being positioned relative to the trailing face of the leading lifter bar to at least partially define a pocket therebetween in which at least a part of an engaged portion of the load is at least partially retainable as the part is raised above a disengaged portion of the load, until said at least one leading surface is located in a predetermined release position, when the part completes exiting the pocket under the influence of gravity.

11. A grinding mill according to claim 10 in which:
each said pair of said lifter bars overlaps with adjacent ones of said pairs of said lifter bars mounted on the inner surface, said adjacent ones of said pairs comprising:
an anterior overlapping pair positioned adjacent to said trailing lifter bar in a central one of said pairs in the direction of rotation relative thereto; and
a following overlapping pair positioned adjacent to said leading lifter bar in said central pair in a direction opposite to the direction of rotation relative thereto; and
in each said central pair of said lifter bars, the leading lifter bar thereof serves as the trailing lifter bar in the anterior overlapping pair thereto, and the trailing lifter bar thereof serves as the leading lifter bar in the following overlapping pair thereto.

12. A grinding mill according to claim 10 which is autogenous.

13. A grinding mill according to claim 10 which is semi-autogenous, and in which the load additionally comprises grinding media.

14. A grinding mill according to claim 10 in which:
each said at least one leading surface extends between a leading outer end, at which said at least one leading surface is proximal to the shell, and a leading inner end, positioned between the shell and the axis; and
each said at least one leading surface is in the release position when the leading inner end is lower than the leading outer end such that each said at least one leading surface is positioned relative to the horizontal at an angle greater than the angle of repose of the load.

15. A grinding mill according to claim 14 in which each said at least one leading surface is positioned at a preselected leading surface angle relative to a leading face tangent therefor, the leading surface tangent being tangential to the shell and orthogonal to a first radius through the axis and the leading inner end.

16. A grinding mill according to claim 15 in which the preselected leading surface angle is an acute angle.

17. A grinding mill according to claim 14 in which each said trailing face extends between a trailing outer end, at which said trailing face is proximal to the shell, and a trailing inner end, positioned between the shell and the axis.

18. A grinding mill according to claim 17 in which each said trailing face is positioned at a preselected trailing face angle relative to a trailing face tangent therefor, the trailing face tangent being tangential to the shell and orthogonal to a second radius through the axis and the trailing face inner end.

19. A grinding mill according to claim 10 in which:
upon each said lifter bar being mounted to the shell, each said lifter bar has an initial height relative to the inner surface of the shell, said initial height being a radial distance from the inner surface to a top surface of the lifter bar; and
the initial heights of selected ones of said lifter bars are less than the initial heights of selected others of the lifter bars.
